(19) United States
(12) Patent Application Publication
(10) Pub. No.: US 2008/0017121 A1
(43) Pub. Date: Jan. 24, 2008

(54) Pet refuse bag holder

(76) Inventor: Tammy Mauro, Vista, CA (US)

Correspondence Address: MS. TAMMY MAURO, 1854 OLYMPUS LOOP DRIVE, VISTA, CA, 92081, US

(21) Appl. No.: 11/489,839

(22) Filed: Jul. 20, 2006

(51) Int. Cl. A01K 29/00

(52) U.S. Cl. 119/161

(57) ABSTRACT

The present invention is an apparatus that is used to hold a bag in which pet refuse or waste is deposited without the need to directly hold the bag with the hands or another item closely associated with the person accompanying the pet, such as the person's clothing. The apparatus is generally comprised of a cord member and a clamping member. A bag-holding loop and a leach-connecting loop are formed in the cord member by the clamping member. The pet refuse bag is held within the bag-holding loop by sliding the clamping member down the cord member until the clamping member is adjacent to the bag. The leash-connecting loop is attached to a pet leash or a cord connecting member, which may be attached to a pet leash. The present invention also includes a method of using the apparatus.

### BACKGROUND

The present invention generally relates to an apparatus that may be used to hold pet refuse or waste, and more specifically an apparatus of this type that may be connected to a pet leash or that may be a part of a pet leash.

It is a common requirement that pets in public places, such as parks and walkways, be connected to a leash that is controlled by the person accompanying the pet. There are also many instances where a leash is desired to control the movement of a pet located on private premises. In addition, there is also often a requirement or desire that the person accompanying the pet promptly remove any refuse or waste deposited by the pet on the premises. In these cases, the person often carries a bag, which is used to scoop up and retain the deposited pet refuse. After retrieving the pet refuse in the bag, the person often ties a knot in the bag adjacent to the bag opening so that neither the refuse, nor the odor it produces, escapes from the bag. For obvious reasons, the person typically does not desire to hold the bag with his or her hands or anything closely associated with the person (such as a pocket in the clothing) after retrieving the waste. Thus, there is a need for an apparatus that may be used to carry the bag until the bag may be properly disposed of, in which the person is not required to directly contact the bag after retrieving the pet refuse. There is also the need for the apparatus to be lightweight and unobtrusive so that it does not interfere with the enjoyment of time spent with the pet. Further, the apparatus needs to be easy to use, especially in light of the ongoing need to control the movement of the pet. Further still, the apparatus needs to be inexpensive to manufacture.

### SUMMARY

The present invention is directed to an apparatus that meets the needs discussed above in the Background section. As described in greater detail below, the present invention, when used for its intended purposes, has many advantages over other devices known in the art, as well as novel features that result in a new apparatus and a new method for its use that are not anticipated, rendered obvious, suggested, or even implied by any prior art devices or methods, either alone or in any combination thereof.

In one version, the present invention is comprised of an apparatus used to hold a pet refuse bag. In this version, the apparatus is comprised of a cord member, cord connecting means to connect the cord member to a pet leash, and slideable clamping means having a passageway therein bounded by two entry points. Both the cord connecting means and the slideable clamping means are described in more detail below. The cord member is positioned in the passageway in a manner so that a leash-connecting loop is formed in the cord member adjacent to the slideable clamping means at one entry point of the passageway. A bag-holding loop is formed in the cord member adjacent to the slideable clamping means at the other entry point of the passageway. The leash-connecting loop is connected to the cord connecting means. A portion of a pet refuse bag is placed within the bag-connecting loop, so that the slideable clamping means may be slid down the cord member along the bag-holding loop until the slideable clamping means is positioned approximately adjacent to the pet refuse bag. The slideable clamping means may then be clamped to the portion of the cord member positioned within the passageway of the slideable clamping means so that the pet refuse bag is held securely within the bag-holding loop. In some embodiments of this version, the cord connecting means may be comprised of an aperture positioned in the pet leash. The leash-connecting loop is connected to the pet leash by a portion of the leash-connecting loop being positioned within the aperture. Alternatively, the cord connecting means may be comprised of a fastener, in which the fastener attaches a portion of the leash-connecting loop to the pet leash. In other embodiments, the slideable clamping means may be a mechanical toggle holding device, a buckle-type clasp, a friction collar, or another type of clamping device. In still other embodiments, the apparatus may further comprise the pet refuse bag, the pet leash, or both.

In another version of the present invention, the apparatus is comprised of a cord member, a cord connecting member, and a slideable clamping member having a passageway therein bounded by two entry points. In this version, cord connecting means are used to connect the leash-connecting loop of the cord member to the cord connecting member and member connecting means are used to connect the cord connecting member to a pet leash. Both the cord connecting means and the member connecting means are described in more detail below. In this version, and except as described in more detail elsewhere herein, the apparatus has substantially the same structure, features, functions and characteristics as the first version of the present invention described above. In some embodiments, the member connecting means may be comprised of an adhesive positioned on a surface of the cord connecting member. The adhesive may be covered with a peel-off strip that is removed from the adhesive, exposing the adhesive, prior to attachment of the cord connecting member to the pet leash. The cord connecting member is attached to a surface of the pet leash by means of the adhesive. In this version, some embodiments may also further comprise the pet refuse bag, the pet leash, or both.

The present invention also includes a method of securing and holding a pet refuse bag to a pet leash using the apparatus of the present invention. The method generally comprises the following described actions. A portion of a pet refuse bag is placed within the bag-connecting loop portion of the cord member. Next, the slideable clamping member is slid down the cord member along the bag-holding loop until the slideable clamping member is positioned approximately adjacent to the pet refuse bag. Next, the slideable clamping member is clamped to the portion of the cord member positioned within the passageway of the slideable clamping member so that the pet refuse bag is held securely within the bag-holding loop.

The apparatus and method of the present invention therefore meet the requirements set forth above in the Background section above. For example, using the disclosed apparatus and method, a pet refuse bag may be removably connected to a pet leash. Thus, the person holding the pet leash is not required to hold the pet refuse bag with his or her hands or anything closely associated with the person (such as a pocket in the clothing) after retrieving the waste. In addition, the apparatus is lightweight and unobtrusive so that it does not interfere with the enjoyment of time spent with the pet. Further, the apparatus is easy to use, especially in light of the ongoing need to control the movement of the pet. Further still, the apparatus is inexpensive to manufacture.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the following appended drawings:

FIG. 1, which is a perspective view of an embodiment of the apparatus of the present invention from above and to the side of the apparatus;

FIG. 2A, which is a perspective view of another embodiment of the slideable clamping means of the apparatus of FIG. 1;

FIG. 2B, which is a perspective view of yet another embodiment of the slideable clamping means of the apparatus of FIG. 1;

FIG. 3, which is a perspective view of yet another embodiment of the slideable clamping means of the apparatus of FIG. 1;

FIG. 4, which is a perspective view of another embodiment of the apparatus of the present invention from above and to the side of the apparatus; and

FIG. 5, which is a plan view of the connecting surface of the cord connecting member of the embodiment of the apparatus illustrated in FIG. 4, as taken along the lines 5-5 in FIG. 4;

FIG. 6A, which is a perspective view of another embodiment of the cord connecting member; and

FIG. 6B, which is a perspective view of a cord connecting member removably attached to a conventional lead, which is also shown in perspective view.

### DETAILED DESCRIPTION

Reference will now be made in detail to the preferred embodiments of the present invention, examples of which are illustrated in the accompanying drawings. While the invention will be described in conjunction with the preferred embodiments, it is to be noted that the embodiments are not intended to limit the invention to those embodiments. On the contrary, the invention is intended to cover alternatives, modifications and equivalents that may be included within the spirit and scope of the invention as defined by the appended claims.

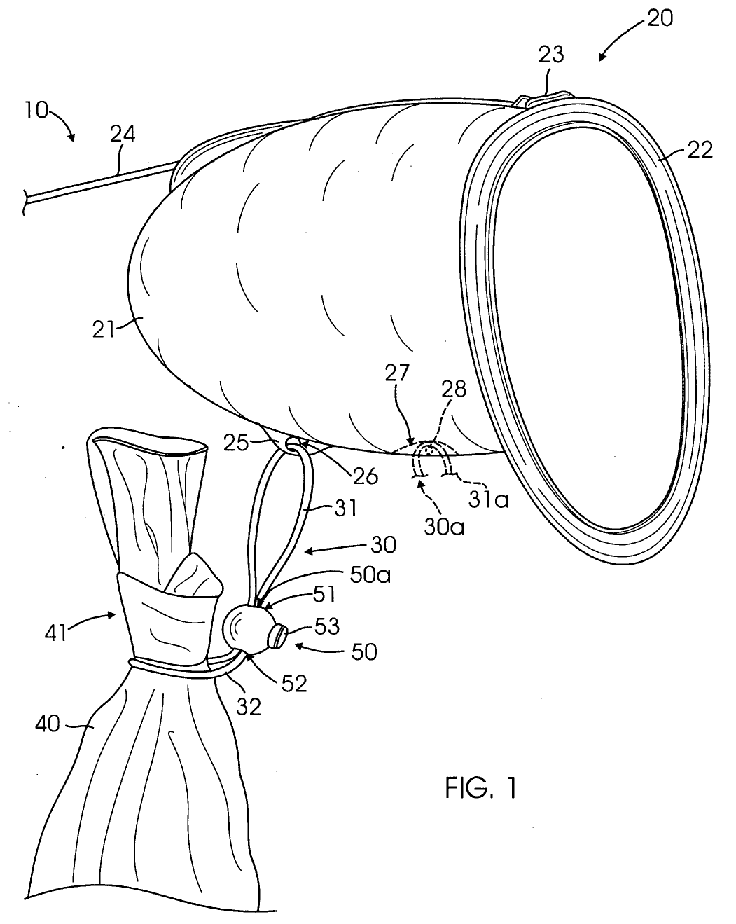

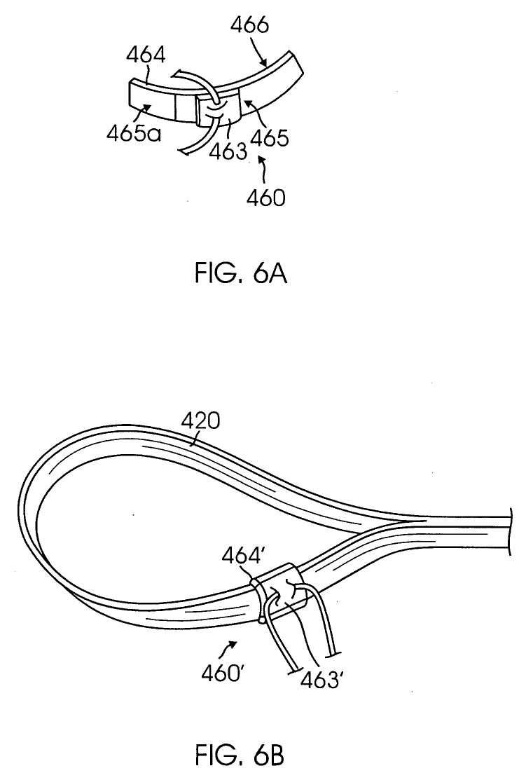

An embodiment of the present invention is represented by the apparatus 10 illustrated in FIG. 1. In this embodiment, the apparatus 10 is generally comprised of a pet leash 20, a cord member 30, cord connecting means to connect the cord member 30 to the pet leash 20, and slideable clamping means. The cord connecting means and slideable clamping means are both described in more detail below. The pet leash 20 illustrated in FIG. 1 is a retractable pet leash 20 generally comprised of a body 21, a handle 22, a cord retraction switch 23, and a retractable cord 24. Although the handle 22 and the outer shell of the body 21 of the pet leash 20 are usually constructed primarily of a plastic material, other materials may also be used in their construction. The user of the apparatus 10 typically holds the pet leash 20 by the handle 22. Using the cord retraction switch 23, the user may cause the retractable cord 24 to be extended from and retrieved to a coil of cord (not illustrated) inside the body 21. This action allows the pet (not illustrated) connected to the distal end of the retractable cord 24 to move farther from the pet leash 20 (and therefore farther from the user of the apparatus 10) or be pulled closer to the pet leash 20 (and therefore closer to the user). This type of pet leash 20 is well known in the relevant art, and the details of its operation are not material to this description of the present invention. It is to be noted that the pet leash 20 of FIG. 1 is illustrative only. In other embodiments, other types of pet leashes may be utilized in lieu of the pet leash 20. For example, the pet leash 20 may be a conventional lead 420, such as a cotton web or leather lead, as illustrated in FIG. 6B, or other types of pet leashes or leads currently known in the art or that may be developed in the art in the future. It is also to be noted that in some embodiments, the present invention is comprised of the cord connecting means, the cord member 30, and the slideable clamping means. In other embodiments, the present invention may be further comprised of the pet leash 20 or the pet refuse bag 40 or both.

The cord member 30 is generally a continuous cord without ends, as illustrated in FIG. 1. Preferably, the cord member 30 is seamless, so that there are no knots or other connectors or fasteners present along its length. It is possible, however, that in other embodiments the cord member 30 could be comprised of a cord with ends, in which the ends are tied together, such as by a square knot, or otherwise fastened together to form the cord member 30. The cord member 30 may be comprised of any materials suitable for use as a cord, as long as the cord member 30 has adequate strength to hold the pet refuse bag 40 in normal operation of the apparatus 10. For example, the cord member 30 may be comprised of rubber (including neoprene) and other elastomers, homogeneous polymers, twisted or woven polymer fibers, cotton fibers, other fibers, cloth, fabrics, or other suitable materials or combinations of such materials. Such materials may allow the cord member 30 to stretch. Preferably, the cord member 30 is comprised of nylon. In addition, the length of the cord member 30, when it is positioned in a manner so that it is linear with two strands positioned side-by-side, is preferably in the range from three inches to eight inches long (from linear end point to end point). More preferably, the cord member 30 is approximately five inches long when placed in this orientation. Further, the cord member 30 preferably has a circular cross-section with a diameter in the range from 1/16th inch to ⅛th inch. In other embodiments, however, the cord member 30 may have a different shaped cross-section. For example, the cross-section of the cord member 30 may be elliptical, arcuate, square, rectangular, triangular, pentagonal, hexagonal or another shape or combination of such shapes.

In the apparatus 10 illustrated in FIG. 1, the slideable clamping means is a mechanical toggle holding device 50 having a passageway 50a therein that is bounded by entry points 51 and 52. A portion of the cord member 30 is positioned in the passageway 50a in a manner so that a leash-connecting loop 31 is formed in the cord member 30 adjacent to the mechanical toggle holding device 50 at one entry point 51 of the passageway 50a and a bag-holding loop 32 is formed in the cord member 30 adjacent to the mechanical toggle holding device 50 at the other entry point 52 of the passageway 50a. When the button 53 of the mechanical toggle holding device 50 is pressed down, the cord member 30 is released so that the mechanical toggle holding device 50 may slide along the cord member 30. When the button 53 of the mechanical toggle holding device 50 is released, the cord member 30 is held in position in the passageway 50a so that the mechanical toggle holding device 50 does slide along the cord member 30. In operation, a portion of a pet refuse bag 40 is placed within the bag-connecting loop 32. The mechanical toggle holding device 50 is then slid down the cord member 30 along the bag-holding loop 32 until the mechanical toggle holding device 50 is positioned approximately adjacent to the pet refuse bag 40. The mechanical toggle holding device 50 may then be clamped to the portion of the cord member 30 positioned within the passageway 50a of the mechanical toggle holding device 50 so that the pet refuse bag 40 is held securely within the bag-holding loop 32. Preferably, there is a knot 41 tied approximately adjacent to the opening of the pet refuse bag 40 to prevent the refuse and associated odor from escaping from the pet refuse bag 40 and to assist the bag-holding loop 32 in holding the pet refuse bag 40. To release the pet refuse bag 40, the mechanical toggle holding device 50 is unclamped from the cord member 30 and slid down the cord member 30 along the leash-connecting loop 31 a distance until the pet refuse bag 40 can be removed from the bag-holding loop 32.

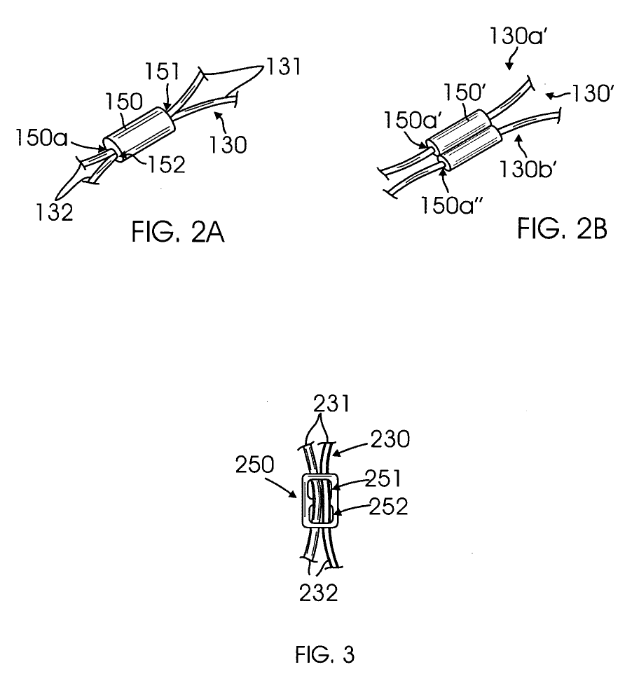

It is to be noted that in other embodiments, the slideable clamping means may take another form. For example, as illustrated in FIG. 2A, the slideable clamping means may be in the form of a friction collar 150 having a passageway 150a therein that is bounded by entry points 151 and 152. In this embodiment, a portion of the cord member 130 is positioned within the passageway 150a of the friction collar 150 in a manner so that a leash-connecting loop 131 is formed in the cord member 130 adjacent to the friction collar 150 at one entry point 151 of the passageway 150a, and a bag-holding loop 132 is formed in the cord member 130 adjacent to the friction collar 150 at the other entry point 152 of the passageway 150a. The passageway 150a and the cord member 130 each have a cross-sectional shape and diameter such that the friction collar 150 is held in place relative to the cord member 130 by friction. When an adequate force is applied longitudinally against the friction collar 150 while the cord member 130 is held in place, the friction collar 150 slides along the cord member 130 until the force is removed, at which point the friction collar 150 is once again held in place (clamped) relative to the cord member 130 by friction. Thus, the bag (not illustrated) can be placed in the bag-holding loop 132, and the friction collar 150 may be slid along the cord member 130 until the friction collar 150 is approximately adjacent to the bag. The friction collar 150 is then held in place by friction (clamped), allowing the bag to be held in the bag-holding loop 132 until a force is applied to the friction collar 150, moving it away from the bag and thereby releasing the bag. In yet another embodiment, as illustrated in FIG. 2B, the passageway 150a′, 150a″ of the friction collar 150′ may be comprised of two channels 150a′, 150a″. In this embodiment, the friction collar 150′ may have substantially the same type of features, structure and operation as the friction collar 150 described above and illustrated in connection with FIG. 2A, except that the passageway 150a′, 150a″ is comprised of two separate channels 150a′, 150a″ and each channel 150a′, 150a″ has a portion 130a′, 130b′ of the cord member 130′ positioned therein. Each portion 130a′, 130b′ of the cord member 130′ is held in place relative to the friction collar 150′ by friction. As yet another example, as illustrated in FIG. 3, the slideable clamping means may take the form of a buckle-type clasp 250. In this embodiment, a portion of the cord member 230 is positioned within the “passageway” of the clasp 250, which is generally comprised of two apertures 251, 252 that also function as entry points to the clasp 250 for the cord member 230. Thus, the leash-connecting loop 231 is formed adjacent to aperture 251 and the bag-holding loop 232 is formed adjacent to aperture 252. The clasp 250 is held against the cord member 230 by friction when the cord member 230 is pulled tightly through the apertures 251, 252. The clasp 250 may be slid along the cord member 230 when the cord member 230 has a loop on the side of the apertures 251, 252 opposite the side of the clasp 250 where the cord member 230 enters the apertures 251, 252. In yet other embodiments, the slideable clamping means may be other types of devices, such as cam-type clamps, clips, or other suitable devices or combinations of such devices currently known in the art or that may be developed in the art in the future. It is also to be noted that the “passageway” of the slideable clamping means may take many shapes and forms.

In the apparatus 10 illustrated in FIG. 1, the cord connecting means is comprised of a protruding member 25 having an aperture 26 therein. In this embodiment, the leash-connecting loop 31 of the cord member 30 is connected to the protruding member 25 (as the cord connecting means) by positioning the leash-connecting loop 31 of the cord member 30 in the aperture 26 in the manner illustrated in FIG. 1. The aperture 26 in the protruding member 25 may have any suitable shape. In other embodiments, the cord connecting means may take any suitable form. For example, as is also illustrated in FIG. 1, the cord connecting means may be comprised of a recess 27 and a pin 28 (both shown in phantom in FIG. 1). In this case, the leash-connecting loop 31a of the cord member 30a (both shown in phantom in FIG. 1) is positioned in the recess 27 in the manner illustrated in FIG. 1. In yet other embodiments, the cord connecting means used to connect the leash-connecting loop 31 to the pet leash 20 may take the form of another suitable fastener, such as glue, adhesive, adhesive tape, screws, nuts and bolts, pins, dowels, nails, clamps, clasps, brackets, hook and loop fasteners (such as VELCRO), or other means or combinations of such means.

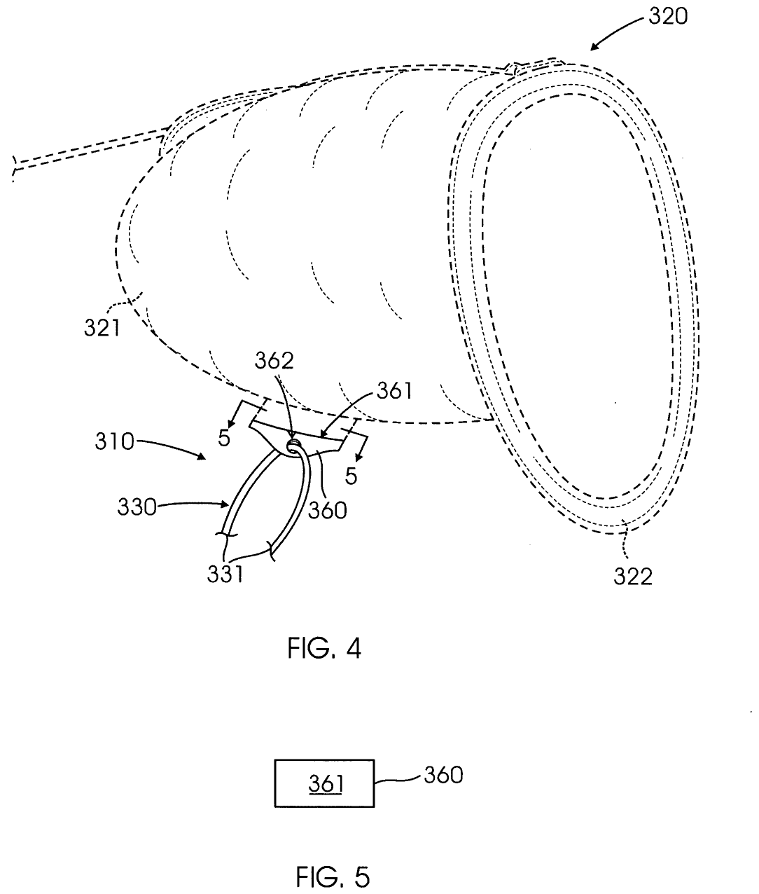

Another embodiment of the present invention is illustrated in FIG. 4. In this embodiment, the apparatus 310 has substantially the same structure, features, functions and characteristics as the embodiment of the apparatus 10 described above and illustrated in connection with FIG. 1, except that the apparatus 310 is comprised of a cord connecting member 360 instead of a pet leash 20. The embodiment of the apparatus 310 illustrated in FIG. 4 is also comprised of member connecting means, which are described in more detail below, to connect the cord connecting member 360 to a pet leash 320. In this embodiment, the leash-connecting loop 331 of the cord member 330 is connected to the cord connecting member 360 by cord connecting means. The cord connecting means of the apparatus 310 may have substantially the same structure, features, functions and characteristics as the cord connecting means of the apparatus 10 described above and illustrated in connection with FIG. 1, except that the cord connecting means of the apparatus 310 is used to connect the leash-connecting loop 331 to the cord connecting member 360 instead of a pet leash 20. The cord connecting member 360 may have almost any shape as long as at least one surface of the cord connecting member 360 is of a size and shape adapted to be connected to the pet leash 320 using the member connecting means, which are described in more detail below. For example, the cord connecting member 360 may have shapes and surfaces that are wholly or partially spheroidal, ellipsoidal, polygonal, or having other linear or arcuate surfaces, contours or shapes or combinations of such shapes. In addition, the aperture 362 in the cord connecting member 360 may have any suitable shape. Preferably, the cord connecting member 360 has the shape illustrated in FIG. 4 and FIG. 5. In the embodiment illustrated in FIG. 4 and FIG. 5, the surface 361 of the cord connecting member 360 is adapted to be attached to the lower surface of the body 321 of the pet leash 320 in the manner illustrated in FIG. 4. In other embodiments, the cord connecting member 360 may be attached to other portions or surfaces of the pet leash 320. The cord connecting member 360 may also be constructed of any suitable material. For example, the cord connecting member 360 may be constructed of metal, minerals, cloth, fabric, leather, glass, wood, cork, bone, plastics or other polymers, ceramics, paper, fiberglass, resins, or other artificial and naturally occurring materials, or combinations of such materials. Preferably, the cord connecting member 360 is constructed of a material that allows the surface 361 to flex slightly to accommodate curvatures in the surface of the pet leash 320 to which the cord connecting member 360 is connected. More preferably, the cord connecting member 360 is constructed of a semi-rigid polymer, such as silicone or nylon. The member connecting means may be comprised of any means suitable to connect the cord connecting member 360 to the pet leash 320. For example, the member connecting means may be comprised of an adhesive (not illustrated) positioned on the surface 361 of the cord connecting member 360 that is to be connected to the pet leash 320. The adhesive may be covered with a peel-off strip (not illustrated) that is removed from the adhesive, exposing the adhesive, prior to attachment of the cord connecting member 360 to the pet leash 320. The cord connecting member 360 is attached to a surface of the pet leash 320 by means of the adhesive. Examples of adhesive/peel-off strips that are suitable for this purpose include 3M VHB Tapes and 3M Double Coated Tapes with release liner that are sold by the 3M Company. In other embodiments, the member connecting means may be comprised of hook and loop fasteners, such as VELCRO. For example, the surface 361 of the cord connecting member 360 may have the hook portions (not illustrated) positioned thereon and the portion of the surface of the pet leash 320 to which the cord connecting member 360 is attached may have the loop portions (not illustrated) positioned thereon, so that the cord connecting member 360 may be removably connected to the pet leash 320 using the hook and loop fasteners. Another example of how hook and loop fasteners may be utilized is illustrated in FIG. 6A and FIG. 6B. In this embodiment, the connecting member 460, 460′ is comprised of a cord connecting portion 463, 463′ and a strap portion 464, 463′, respectively. The cord connecting portion 463 may be mounted on the strap portion 464, as illustrated in FIG. 6A, or the cord connecting member 463′ may be incorporated as a part of the strap portion 464′, as illustrated in FIG. 6B. It is to be noted that the connecting portion 463, 463′ and the strap portion 464, 464′ may be of almost any shape or size as long as they may be used to connect the cord connecting member 460, 460′ to the pet leash 420. The surface 465 of the strap portion 464 that faces away from the pet leash 420 has hook portions positioned on one portion 465a thereof. The surface 466 of the strap portion 464 that faces toward the pet leash 420 has loop portions (not illustrated) positioned on a portion thereof, so that the hook portions and the loop portions removably interconnect when the strap portion 464 of the cord connecting member 460 is wrapped around the pet leash 420, as described below. In operation, as illustrated in FIG. 6B, the cord connecting member 460′ is placed approximately adjacent to a surface of the pet leash 420 and the distal portions of the strap portion 464′ are wrapped around the pet leash 420 until the hook and loop fasteners interface to make a removable connection. It is to be noted that in other embodiments the hook portions and loop portions may be positioned on different surfaces of the cord connecting member 460, 460′, which can be wrapped around the pet leash 420 in different ways. It is also to be noted that the cord connecting member 460, 460′ may also be used in conjunction with the pet leash 320 illustrated in FIG. 4. For example, the cord connecting member 460, 460′ may be connected to the handle 322 of the pet leash 320 in a manner similar to that described above and illustrated in connection with FIG. 6B. Referring again to FIG. 4 and FIG. 5, in still other embodiments, the member connecting means used to connect the cord connecting member 360 to the pet leash 320 may take other suitable forms of permanent or removable means, such as glue, adhesive, adhesive tape, screws, nuts and bolts, pins, dowels, nails, clamps, clasps, brackets, or other means or combinations of such means. It is to be noted that in yet other embodiments, the apparatus 310 may further comprise the pet leash 320 (or 420) or the bag (not illustrated), or both.

Referring again to the apparatus 10 of FIG. 1 as an example, the present invention also includes a method of securing and holding a pet refuse bag 40 to a pet leash 20. Generally, the method comprising the following actions. First, a portion of the pet refuse bag 40 is placed within the bag-connecting loop 32 of the cord member 30. Next, a slideable clamping member (the mechanical toggle holding device 50 in the embodiment of FIG. 1) is slid down the cord member 30 along the bag-holding loop 32 until the slideable clamping member 50 is positioned approximately adjacent to the pet refuse bag 40. The slideable clamping member 50 is then clamped to the portion of the cord member 30 positioned within the passageway of the slideable clamping member 50 so that the pet refuse bag 40 is held securely by the bag-holding loop 32.

What is claimed is:

1. An apparatus used to hold a pet refuse bag, the apparatus comprising:
(a) a cord member;
(b) cord connecting means to connect the cord member to a pet leash; and
(c) slideable clamping means having a passageway therein bounded by two entry points;
(d) wherein:
(i) the cord member is positioned in the passageway in a manner so that a leash-connecting loop is formed in the cord member adjacent to the slideable clamping means at one entry point of the passageway and a bag-holding loop is formed in the cord member adjacent to the slideable clamping means at the other entry point of the passageway;
(ii) the leash-connecting loop is connected to the cord connecting means; and
(iii) a portion of a pet refuse bag is placed within the bag-connecting loop, so that the slideable clamping means may be slid down the cord member along the bag-holding loop until the slideable clamping means is positioned approximately adjacent to the pet refuse bag and the slideable clamping means may be clamped to the portion of the cord member positioned within the passageway in the slideable clamping means so that the pet refuse bag is held securely within the bag-holding loop.

2. The apparatus of claim 1, wherein the cord connecting means is comprised of an aperture positioned in the pet leash and the leash-connecting loop is connected to the pet leash by a portion of the leash-connecting loop being positioned within the aperture.

3. The apparatus of claim 1, wherein the cord connecting means is comprised of a fastener and the fastener attaches a portion of the leash-connecting loop to the pet leash.

4. The apparatus of claim 1, wherein the slideable clamping means is a mechanical toggle holding device.

5. The apparatus of claim 1, wherein the slideable clamping means is a buckle-type clasp.

6. The apparatus of claim 1, wherein the slideable clamping means is a friction collar.

7. The apparatus of claim 1, further comprising the pet refuse bag.

8. The apparatus of claim 1, further comprising the pet leash.

9. An apparatus used to hold a pet refuse bag, the apparatus comprising:
(a) a cord member;
(b) a cord connecting member;
(c) member connecting means to connect the cord connecting member to a pet leash;
(d) cord connecting means to connect the cord member to the cord connecting member; and
(e) a slideable clamping member having a passageway therein bounded by two entry points;
(f) wherein:
(i) the cord member is positioned in the passageway in a manner so that a leash-connecting loop is formed in the cord member adjacent to the slideable clamping member at one entry point of the passageway and a bag-holding loop is formed in the cord member adjacent to the slideable clamping member at the other entry point of the passageway;
(ii) the leash-connecting loop is connected to the cord connecting means; and
(iii) a portion of a pet refuse bag is placed within the bag-connecting loop, so that the slideable clamping member may be slid down the cord member along the bag-holding loop until the slideable clamping member is positioned approximately adjacent to the pet refuse bag and the slideable clamping member may be clamped to the portion of the cord member positioned within the passageway in the slideable clamping member so that the pet refuse bag is held securely within the bag-holding loop.

10. The apparatus of claim 9, wherein:
(a) the member connecting means is comprised of an adhesive positioned on a surface of the cord connecting member; and
(b) the adhesive is covered with a peel-off strip that is removed from the adhesive, exposing the adhesive, prior to attachment of the cord connecting member to the pet leash; and
(c) the cord connecting member is attached to a surface of the pet leash by means of the adhesive.

11. The apparatus of claim 9, wherein the cord connecting means is comprised of an aperture positioned in the cord connecting member and the leash-connecting loop is connected to the cord connecting member by a portion of the leash-connecting loop being positioned within the aperture.

12. The apparatus of claim 9, wherein the cord connecting means is comprised of a fastener and the fastener attaches a portion of the leash-connecting loop to the cord connecting member.

13. The apparatus of claim 9, wherein the slideable clamping member is a mechanical toggle holding device.

14. The apparatus of claim 9, wherein the slideable clamping means is a friction collar.

15. The apparatus of claim 9, further comprising the pet refuse bag.

16. The apparatus of claim 9, further comprising the pet leash.

17. A method of securing and holding a pet refuse bag to a pet leash, the method comprising the following actions:
(a) placing a portion of a pet refuse bag within a bag-connecting loop portion of a cord member, wherein:
(i) another portion of the cord member is positioned within a passageway of a slideable clamping member, wherein the passageway is bounded by two entry points, so that a leash-connecting loop is formed in the cord member adjacent to the slideable clamping member at one entry point of the passageway and the bag-holding loop is formed in the cord member adjacent to the slideable clamping member at the other entry point of the passageway, and
(ii) the leash-connecting loop is connected to the pet leash by cord connecting means;
(b) sliding the slideable clamping member down the cord member along the bag-holding loop until the slideable clamping member is positioned approximately adjacent to the pet refuse bag; and
(c) clamping the slideable clamping member to the portion of the cord member positioned within the passageway of the slideable clamping member so that the pet refuse bag is held securely within the bag-holding loop.

18. The method of claim 17, wherein the cord connecting means is comprised of an aperture positioned in the pet leash and the leash-connecting loop is connected to the pet leash by a portion of the leash-connecting loop being positioned within the aperture.

19. The apparatus of claim 17, wherein the slideable clamping member is a mechanical toggle holding device.

20. The apparatus of claim 17, wherein the slideable clamping member is a friction collar.
